(19) United States
(12) Patent Application Publication
(10) Pub. No.: US 2017/0077770 A1
(43) Pub. Date: Mar. 16, 2017

(54) ELECTRIC MACHINE WITH A ROTOR COOLED BY COOLING GAS

(71) Applicant: SIEMENS AKTIENGESELLSCHAFT, 80333 München (DE)

(72) Inventors: MARCO FESTA, Falkensee (DE); MATTHIAS CENTNER, Berlin (DE); ILJA SABELFELD, Berlin (DE)

(73) Assignee: SIEMENS AKTIENGESELLSCHAFT, 80333 München (DE)

(21) Appl. No.: 15/123,446

(22) PCT Filed: Feb. 26, 2015
(86) PCT No.: PCT/EP2015/053978

§ 371 Date: Sep. 2, 2016

(30) Foreign Application Priority Data
Mar. 6, 2014 (EP) 14158039.9

(51) Int. Cl. H02K 1/20

(52) U.S. Cl. CPC H02K 1/20

(57) ABSTRACT

An electric machine includes a rotor and a stator which is disposed in surrounding relation to the rotor and includes a plurality of laminated sub-cores arranged behind one another in an axial direction which is parallel to an axis of rotation of the rotor. Adjacent ones of the laminated sub-cores are separated from one another by a flow channel which is open in a direction of the rotor to allow supply of cooling gas to the rotor for cooling the rotor. A channel plate is placed to delimit a laminated sub-core from the flow channel. The channel plate has a rotor-side end section to deflect a cooling gas flow along the flow channel from a radial direction that points toward the axis of rotation.

The invention relates to an electric machine with a rotor cooled by means of a cooling gas.

With an electric machine of this type, the rotor is cooled from the outside across its lateral surface. Here the flow conduction of the cooling gas near to the surface is key to the effectiveness of the rotor cooling. With large machines, the rotors of which are cooled in this way, the cooling gas usually enters the air gap between the rotor and stator axially from both ends, is heated as a result of rotor losses and air friction losses and then leaves the air gap in a radial direction via ventilation ducts in the stator.

JP H04 156252 A and JP 2003 018772 A each disclose an electric machine, the stator of which has cooling ducts extending radially in order to cool its rotor.

The object underlying the invention is to specify an electric machine, which is improved in particular in respect of rotor cooling, with a rotor cooled by means of a cooling gas.

The object is achieved in accordance with the invention by the features of claim 1.

Advantageous embodiments of the invention are the subject matter of the subclaims.

An inventive electric machine has a rotor cooled by means of a cooling gas and a stator which surrounds the rotor. The stator has a number of laminated sub-cores, which are arranged one behind the other in an axial direction which is parallel to an axis of rotation of the rotor and are separated from one another by flow channels which are open on the rotor side in order to supply cooling gas to the rotor. Provision is made here for at least one channel plate, which delimits a laminated sub-core from a flow channel and has a rotor-side end section, which deflects a flow of cooling gas running along the flow channel out of a radial direction which points toward the axis of rotation.

The rotor can be supplied directly with cooling gas through the flow channels arranged between the laminated sub-cores, as a result of which the rotor can advantageously be supplied more effectively with the cooling gas than by means of the known axial introduction of cooling gas into the air gap between the stator and rotor, because the relation between a benefit achieved by a thermal transition index and an effort determined by the flow power is improved.

An impact flow directed from a flow channel perpendicularly onto the outer surface of the rotor is prevented by means of the at least one channel plate. A precisely perpendicular impact flow is disadvantageous since it results in a high pressure loss and spreads out from all sides of the center of the impact point and as a result hinders the main flow. The high pressure loss has to be compensated by a high fan pressure and would require the fan which generates the fan pressure to have a high power requirement.

One embodiment of the invention provides for at least one channel plate pair of two channel plates of this type, wherein each of the two channel plates delimits one of two adjacent laminated sub-cores with respect to the flow channel which separates these laminated sub-cores.

A channel plate pair of this type can direct the flow of the cooling gas through a flow channel from two sides and thus more effectively.

A further embodiment of the afore-cited embodiment of the invention provides that the rotor-side end sections of the channel plates of a channel plate pair have surfaces on the flow channel side which are embodied such that tangential planes on these surfaces in the rotor-side boundary points of the surfaces are at least almost parallel to one another and form non-zero angles with a plane which is orthogonal to the axis of rotation.

This further development advantageously enables the cooling gas flow leaving a flow channel to be directed by means of the surfaces of the rotor-side end sections of the channel plates in one direction, which has a component which is tangential to the outer surface of the rotor.

A further embodiment of the invention provides that the stator has one channel plate pair for each pair of adjacent laminated sub-cores.

By means of this embodiment of the invention, the cooling gas flow can be advantageously directed on the rotor-side end of each flow channel arranged between two adjacent laminated sub-cores.

A further embodiment of the invention provides that the two channel plates of a channel plate pair are connected to one another by at least one supporting web.

As a result, a gap between two laminated sub-cores can be established advantageously by means of at least one supporting web.

A further embodiment of the invention provides that a rotor-side end section of at least one channel plate has at least one comb, which is embodied to direct a cooling gas flow in one direction with a non-vanishing component which is orthogonal to the axial direction and to the radial direction.

As a result, the cooling gas flow on the rotor-side end of at least one flow channel also obtains a component which is directed orthogonally to the axial direction and tangentially to the outer surface of the rotor. A component of this type has an advantageous effect on the air friction losses and promotes a cooling gas flow with a low pressure loss which runs in the manner of a spiral about the outer surface of the rotor. This embodiment is particularly advantageous if the electric machine is configured for one (preferred) direction of rotation of the rotor.

A further embodiment of the invention provides that a rotor-side end section of at least one channel plate has a reinforcing element.

A reinforcement of an end section of a channel plate can be produced particularly advantageously if the channel plate is produced as a stamped formed part.

A further embodiment of the invention provides that each laminated sub-core has a number of grooves distributed around the axis of rotation, through which windings of stator coils of the stator are guided, and that each channel plate of a laminated sub-core has recesses which correspond to the grooves.

This embodiment of the invention advantageously takes into account that a stator usually has grooves for the stator coils and adjusts the design of the channel plates to this embodiment of a stator.

A further embodiment of the invention provides that each channel plate is manufactured from a metal or from a metal alloy.

A metal or a metal alloy is particularly advantageously suitable as a material of a channel plate, since it enables a stable and weldable embodiment of the channel plate. In this context, it should be noted that contrary to the usual meaning of the word “sheet metal”, the term “channel plate” does not necessarily imply in this application that the channel plate is manufactured from a metal or a metal alloy.

The above-described characteristics, features and advantages of this invention, as well as the manner in which these are realized, will become more clearly and easily intelligible in connection with the following description of exemplary embodiments which are explained in more detail with reference to the drawings, in which:

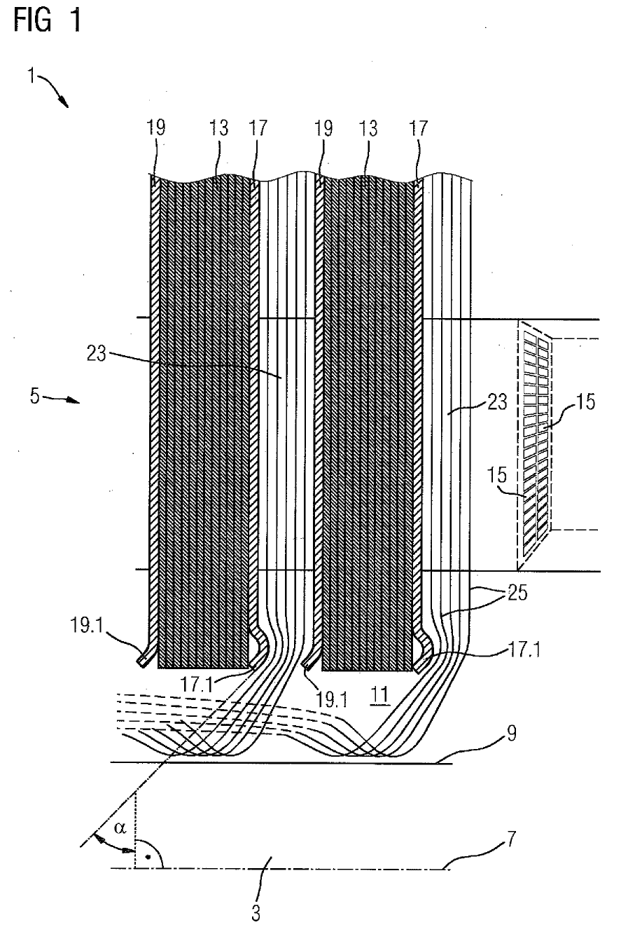

FIG. 1 shows a schematic representation of a cutout of a longitudinal section through an electric machine,

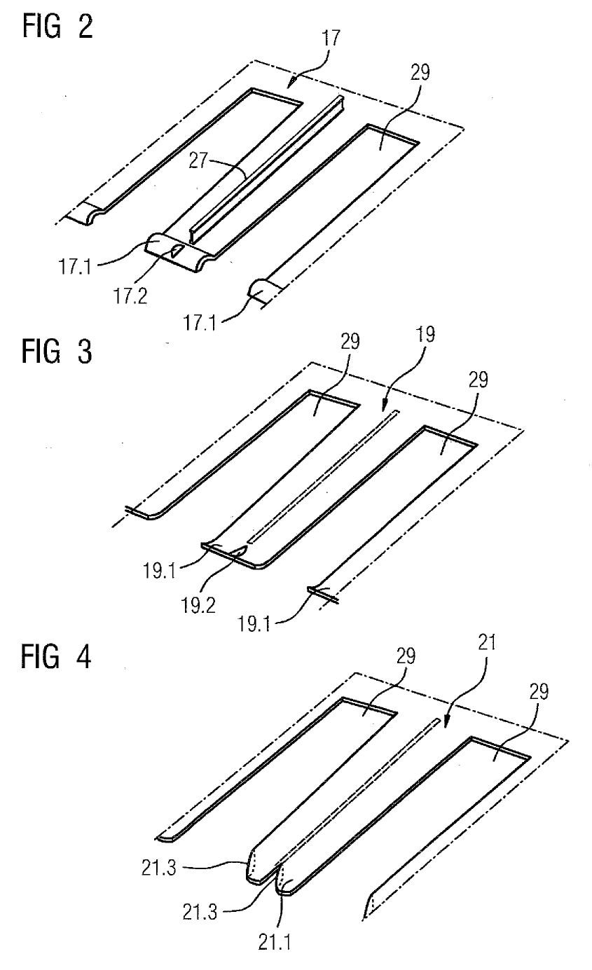

FIG. 2 shows a perspective representation of a section of a first channel plate,

FIG. 3 shows a perspective representation of a section of a second channel plate, and

FIG. 4 shows a perspective representation of a section of a third channel plate.

Parts which correspond to one another are provided with the same reference signs in all the figures.

FIG. 1 shows a cutout of a longitudinal section through an electric machine 1 with a rotor 3 and a stator 5 which surrounds the rotor.

The rotor 3 is mounted so as to be rotatable about an axis of rotation 7 and is embodied in a substantially circular cylinder shape, wherein the cylinder axis coincides with the axis of rotation 7. The cylinder casing-shaped outer surface 9 of the rotor 3 is separated from the stator 5 by an air gap 11.

The stator 5 has a number of laminated sub-cores 13 arranged one behind the other in an axial direction in parallel to the axis of rotation 7. Each laminated sub-core 13 is embodied in a substantially circular ring shape about the axis of rotation 7 and has a number of grooves (not shown in FIG. 1) distributed about the axis of rotation 7, through which windings (likewise not shown in FIG. 1) of stator coils of the stator 5 are guided in a known manner in each case. Also shown here, in a perspective representation which differs from the rest of the representation of FIG. 1, are conductors 15 which run behind the plane of projection and which are part of the stator coils.

The laminated sub-cores 13 are separated from one another by flow channels 23, which are open on the rotor side, i.e. toward the air gap 11. In order to cool the rotor 3, a cooling gas, air for instance, is guided into the air gap 11 and thus to the outer surface 9 of the rotor 3 through the flow channels 23.

On each side which faces an adjacent laminated sub-core 13, each laminated sub-core 13 has a channel plate 17, 19 channel plate which delimits the laminated sub-core 13 from the flow channel 23 there. Here each laminated sub-core 13 has a first channel plate 17 on one side and a second channel plate 19 on the opposite side, wherein these two channel plates 17, 19 differ from one another.

Furthermore, each two adjacent laminated sub-cores 13 are delimited by two different channel plates 17, 19 from the flow channel 23 which separates these laminated sub-cores 13, i.e. by a first channel plate 17 and a second channel plate 19, which delimit one of the two laminated sub-cores 13 from the flow channel 23 in each case. The two channel plates 17, 19 of a channel plate pair of this type form walls of the flow channel 23 which are disposed opposite one another and are described in further detail below with the aid of FIGS. 2 and 3.

FIG. 2 shows a perspective representation of a section of a first channel plate 17.

FIG. 3 shows a perspective representation of a section of a second channel plate 19.

The channel plates 17, 19 have rotor-side end sections 17.1, 19.1, which are embodied to deflect cooling gas flows running through the flow channels 23 out of the radial directions which point toward the axis of rotation 7. The cooling gas flows are shown in FIG. 1 by flow lines 25.

To guide the flow of cooling gas, the rotor-side end section 17.1 of a first channel plate 17 has a claw-like bulge and the rotor-side end section 19.1 of a second channel plate 19 is bent. Here the end sections 17.1, 19.1 are embodied such that tangential planes on their surfaces in the rotor-side boundary points of these surfaces are at least almost parallel to one another and in each case form a non-zero angle α with a plane which is orthogonal to the axis of rotation 7. As a result, the cooling gas flows leaving a flow channel 23 into the air gap 11 are each deflected approximately by the angle α from the radial directions which point toward the axis of rotation and thus have components which are aligned tangentially and axially in respect of the outer surface 9 of the rotor 3.

The end sections 17.1, 19.1 optionally also have reinforcing elements 17.2, 19.2, which are embodied as notches for instance.

Each first channel plate 17 also has a supporting web 27, which serves as a spacer between adjacent laminated sub-cores 13 and is welded to the second channel plate 19 for instance, which forms a channel plate pair with the first channel plate 17.

Each channel plate 17, 19 also has recesses 29 which correspond to the grooves of the laminated sub-core 13 which is delimited thereby.

FIG. 4 shows a perspective representation of a section of a third channel plate 21, which, as an alternative to the second channel plate 19 shown in FIG. 3, can delimit a laminated sub-core 13. A third channel plate 21 has a rotor-side end section 21.1, which is bent like the rotor-side end section 19.1 of the second channel plate 19, but also has two combs 21.3, which, in order to direct a cooling gas flow in one direction, are each embodied with a non-vanishing component which is orthogonal to the axial direction and to the radial direction. The combs 21.3 are generated in the exemplary embodiment shown in FIG. 4 by bending a corner region and a middle region of the end section 21.1, for which purpose the end section 21.1 is cut in the middle.

1.-9. (canceled)

10. An electric machine, comprising:
a rotor;
a stator disposed in surrounding relation to the rotor and including a plurality of laminated sub-cores arranged behind one another in an axial direction which is parallel to an axis of rotation of the rotor, with adjacent ones of the laminated sub-cores being separated from one another by a flow channel which is open in a direction of the rotor to allow supply of cooling gas to the rotor for cooling the rotor; and
a channel plate placed to delimit a one of the laminated sub-cores from the flow channel, said channel plate having a rotor-side end section configured to deflect a cooling gas flow along the flow channel from a radial direction that points toward the axis of rotation.

11. The electric machine of claim 10, further comprising two of said channel plate to respectively delimit two adjacent ones of the laminated sub-cores from the flow channel which separates the two adjacent ones of the laminated sub-cores.

12. The electric machine of claim 11, wherein the rotor-side end section of each of the two channel plates has a flow channel-side surface, said surfaces of the rotor-side end sections of the channel plates being configured such that tangential planes on the surfaces in rotor-side boundary points of the surfaces are substantially parallel to one another and form non-zero angles with a plane which is orthogonal to the axis of rotation.

13. The electric machine of claim 10, wherein the stator has a channel plate pair for each pair of adjacent ones of the laminated sub-cores.

14. The electric machine of claim 11, wherein the two channel plates are connected to one another by a supporting web.

15. The electric machine of claim 10, wherein the rotor-side end section of the channel plate has at least one comb configured to direct the cooling gas flow in a direction with a component which is orthogonal to the axial direction and to the radial direction.

16. The electric machine of claim 10, wherein the rotor-side end section of the channel plate has a reinforcing element.

17. The electric machine of claim 10, wherein each laminated sub-core has a number of grooves distributed around the axis of rotation for guidance of windings of stator coils of the stator, said channel plate having recesses which correspond to the grooves.

18. The electric machine of claim 10, wherein the channel plate is made from a metal or from a metal alloy.
